(19) United States
(12) Patent Application Publication
(10) Pub. No.: US 2004/0051045 A1
(43) Pub. Date: Mar. 18, 2004

(54) Scintillator detector and camera system and method for measuring emission uniformly and for calibration of radioactive sources

(76) Inventors: Thomas S Jones, Norton Shores, MI (US); Robert Schulte, Gaithersburg, MD (US)

Correspondence Address: FULBRIGHT AND JAWORSKI L L P, PATENT DOCKETING 29TH FLOOR, 865 SOUTH FIGUEROA STREET, LOS ANGELES, CA, 900172576

(21) Appl. No.: 10/297,524

(22) PCT Filed: May 25, 2001
(86) PCT No.: PCT/US01/16873

(51) Int. Cl. G01T 1/20

(52) U.S. Cl. 250/368; 250/363.01

(57) ABSTRACT

A scintillator-camera system for determining uniformity of radiation emission from a radioactive source includes a cylindrical scintillation detector, the scintillation detector having a central hole along the long axis and having a conical mirror around the scintillator to direct light emitted from the circumference of the scintillator to a camera. A camera is arranged to view the scintillation detector so that light stimulated in the scintillator by a radioactive source inserted in the central hole is detected by the camera, the camera producing image data upon detection of light stimulated in the scintillator. The image data are adapted to be analyzed to detect non-uniformity in a radiation emission pattern from the radioactive source. The image from the thick scintillator and surrounding conical mirror provides information about both circumferential, i.e., radial, and axial emission non-uniformities in a single view of the radioactive source(s) or seed(s) within the thick scintillator.

### BACKGROUND AND SUMMARY OF THE INVENTION

This invention relates to the measurement and calibration of radioactive sources and, more particularly, to a scintillator-camera system therefor.

Radioactive sources, emitting x-rays, gamma rays, beta particles or other radiation, are used in many applications, including industrial radiography and gauging, medical therapy and heat and power sources. In many of these applications the uniformity of radiation emission from the source is important. This is particularly true for low activity sources used for brachytherapy. In this case the radioactive source is placed on or inserted into the body to irradiate a tumor or lesion. Uniformity of emission is important, as is a calibration of the radiation emitted so that the radiation dose delivered to the patient can be accurately determined. Present methods for calibration of brachytherapy sources involve a variety of methods, including surrounding the source with multiple detectors, the use of multiple radiation probes or area detectors, such as film, and the use of well ionization chambers to measure the total radiation emitted from the source. These methods are cumbersome and, in many cases do not provide a complete determination of the emitted radiation patterns.

U.S. Pat. No. 5,661,310, which is incorporated by reference, discloses a radiation dose mapping system and method. A dosimeter made of a suitable luminescent material is provided between an image sensor such as a camera that is hooked up to a computer-based controller and a stimulator including an infrared light source. An optical stimulator source filter for producing only a narrow-band infrared spectrum and an optical image filter for preventing light produced by the stimulator from being conveyed to the camera are provided between the stimulator and the dosimeter. The device permits mapping of spatially variable radiation patterns for use in medical radiation treatments and does so without the requirement of chemical processing. The device is not adapted to permit analysis of circumferential variations in a sample, i.e., radial variations, or axial variations in a sample.

The method and system according to the present invention makes use of a thick, cylindrical scintillator observed through a mirror by a camera. If the source to be calibrated is placed in a central hole in the thick scintillator, the emitted light will show variations in both the circumferential, i.e., radial, and axial emission patterns from the source. A conical mirror around the scintillator will direct the emitted light toward the camera. Variations in the circumferential, i.e., radial, radiation emission from the source will be detected as variations in the circumferential pattern of the emitted light from the scintillator. Variations in the axial radiation from the source will be observed in the same image presentation as variations along the radial direction of the round image.

According to one aspect of the present invention, a scintillator-camera system for determining uniformity of radiation emission from one or more radioactive sources includes a cylindrical scintillator having a central hole for receiving one or more radioactive sources, the scintillator being adapted to permit light stimulated in the scintillator by the one or more radioactive sources in the central hole to exit out of the sides of the scintillator. A conical reflector at least partially surrounds the cylindrical scintillator and is arranged to reflect light that exits the sides of the scintillator and direct the light in a first direction. A camera is arranged to detect the light reflected from the conical reflector and produce image data corresponding to the detected light.

According to another aspect of the present invention, a cylindrical scintillator has a central hole for receiving one or more radioactive sources. The scintillator is adapted to permit light stimulated in the scintillator by the one or more radioactive sources in the central hole to exit out of the sides of the scintillator.

According to another aspect of the present invention, a method for determining uniformity of radiation emission from one or more radioactive sources includes inserting a radioactive source in a central hole of a scintillator, the scintillator being adapted to permit light stimulated in the scintillator by the radioactive source in the central hole to exit out of the sides of the scintillator. Light that exits the sides of the scintillator is reflected with a reflector and the light is directed in a first direction. After the light has been directed in the first direction, the light is detected with a camera.

### BRIEF DESCRIPTION OF THE DRAWINGS

The features and advantages of the present invention are well understood by reading the following detailed description in conjunction with the drawings in which like numerals indicate similar elements and in which:

FIG. 1A schematically shows a system configuration for brachytherapy seed profiling with a thick scintillator and a conical mirror according to an embodiment of the present invention;

FIG. 1B is a top view of a portion of the system of FIG. 1A;

FIG. 2 shows an image pattern in a conical mirror for the system shown in FIG. 1A; and

FIG. 3A schematically shows a brachytherapy seed calibration system according to an embodiment of the present invention with stepped phosphor detector;

FIG. 3B is a top view of a portion of the system of FIG. 3A; and

FIG. 4 schematically shows an embodiment of a thick scintillator wherein fibers run radially.

### DETAILED DESCRIPTION OF PREFERRED EMBODIMENTS

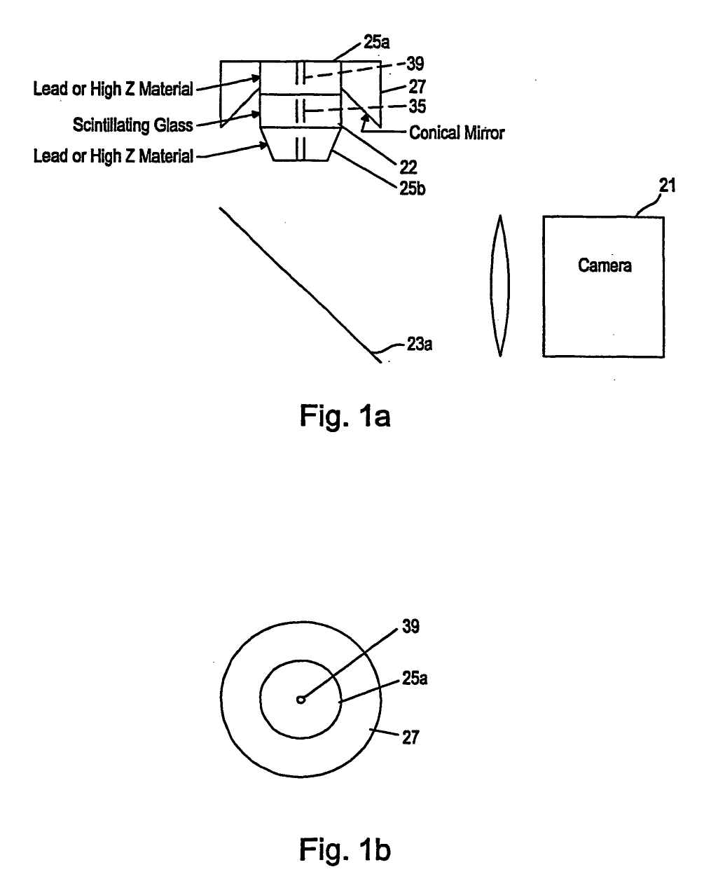

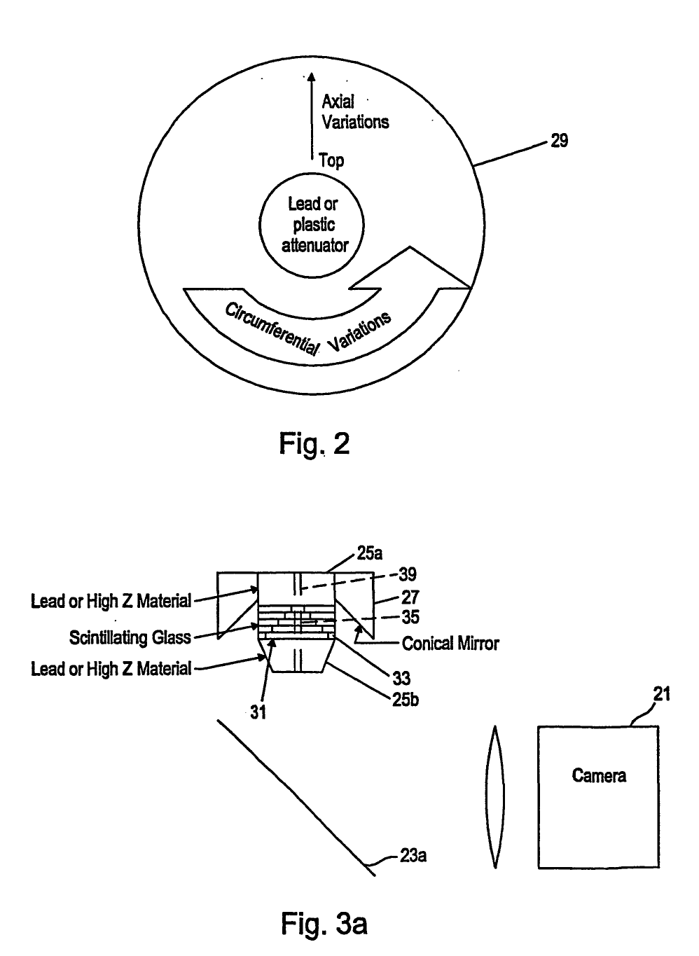

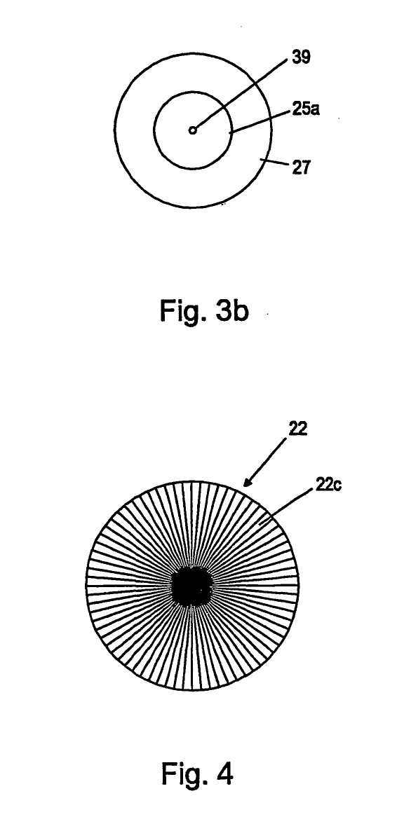

A preferred configuration of the scintillator-camera system can be used to determine the uniformity of emission from a radioactive source. FIG. 1A shows a thick, central hole scintillator 22. The scintillator 22 may be in the form of a solid glass (such as Type IQI 301 or 401, available from Industrial Quality, Inc., Gaithersburg, Md. 20877), an inorganic scintillator such as cesium iodide or sodium iodide (available from Radiation Monitoring Devices, Watertown, Mass.) or other scintillation material. Organic scintillators, plastics, such as BC-400 (available from Saint Gobain Crystals and Detectors, Newbury, Ohio), are preferred for particle emitting radioactive sources, beta particles or positrons. The scintillator 22 may also be in the form of scintillating glass, columnar inorganic scintillator or scintillating plastic fibers in which fibers or columns, 22c run in a radial direction, as shown in FIG. 4. The outer perimeter of the cylindrical scintillator 22 is polished to permit light to exit from the sides as radiation stimulates light emission within the scintillator. A conical reflector 27 around the scintillator reflects the emitted light toward a camera 21. A top shield, 25a, shields the source from the scintillator until the source enters the hole in the scintillator. A bottom shield, 25b, is preferably conical as illustrated to minimize obstructions in the light path but, if desired or necessary, may be cylindrical. FIGS. 1B and 3B show a portion of the system of FIGS. 1A and 3A from the top. The emitted light displays variations in the source radiation emitted in both the circumferential, i.e., radial, and longitudinal directions, as shown in the image 29 seen in FIG. 2. A variation of the first approach, illustrated in FIG. 3A, yields a camera image that can readily relate to the radiation dose delivered to tissue at distances that correlate with the tissue-equivalent plastic separator 31 between the source S and a phosphor layer 33. The image in the embodiments of FIGS. 1A and 3A may be viewed by the camera directly through the conical mirror, or through a turning mirror 23a. The camera 21 can, of course, be associated with a computer for analysis and storage of information about the source and the reference to a camera is meant to encompass any suitable device capable of obtaining and recording or transmitting an image.

The scintillator 22 (glass, inorganic or plastic) is a thick circular cylinder with the outside perimeter surface polished. The outer cylinder wall of the scintillator 22 is viewed through a conical mirror, shown as item 27. This approach permits superior shielding of the active portions of the seeds or strings of seeds that are either above or below the active scintillator 22, as provided by shields 25a and 25b in FIGS. 1A and 3A. In this approach, the circumferential, i.e., radial, symmetry of the source activity is imaged as brightness variations around the perimeter of the scintillator 22. A string of radioactive seeds, as typically used for some brachytherapy applications, may be totally contained within the long scintillating cylinder, thereby avoiding problems caused by radioactive material above or below the scintillator. Variations in the axial activity display as variations in brightness in the radial direction of the resulting image 29. This is illustrated in FIG. 2. A variant of this approach would use a solid, tissue-equivalent plastic absorbing cylinder with a fluorescent phosphor, such as gadolinium-oxysulfide, on the outer surface. This approach offers the advantage of displaying a signal that relates to the dose deposited in tissue at a fixed distance away from the seeds. Due to scatter in the absorber, the local variations in intensity at the surface of the seed will be blurred but the resultant light detected by the camera will be an accurate representation of the dose at the plastic cylinder distance. Another possibility with this approach is shown in FIG. 3A (top view shown in FIG. 3B) and uses a conical shaped plastic separator or a stacked sequence of plastic discs in which the phosphor is located at different radial positions. With this approach, the variation in dose with distance from the seeds can be imaged. This approach could be taken to the limit where the phosphor is coated on the inner wall of the hole in the plastic material to place it in close proximity to the seed(s).

The shields, 25a and 25b, are preferably made of a material having an atomic number that is appropriately high for the isotope being imaged, such as lead or tungsten alloy for gamma or x-ray emitting sources. Leaded glass or plastic shields can be effectively used as the bottom shield, 25b, in order to allow a clear visible path for the emitted light to reach the camera. For the particle emitting sources, beta particles or positrons, the shield material should not be made of high atomic number materials, so as to avoid the production of x-rays in the shield material. Clear plastic shields, such as polyethylene, are preferred.

The final result obtained from this invention is a representation of the radiation emission pattern from a radioactive source or a string of such sources. For brachytherapy applications, these radiation data can be related to radiation dose delivered to a patient, thereby making the radiation therapy more efficient and safer to use. The scintillator-camera system described here offers a rapid, complete characterization of the radiation pattern emitted by a radioactive source.

The system is operated through a user interface developed using virtual instrumentation and serves as the operator control panel. Image acquisition and image conversion is automatically handled by the custom designed software. Due to the nature of the conical mirror assembly, the brightness or light intensity varies along the radial direction of the mirror surface. This is due to the variation of distance between the surface of the mirror and the surface of the scintillator along its axis, so the light intensity variation is intrinsic to the design of the mirror assembly. A portion of the control system software is a correction algorithm that accepts the image of the mirror assembly and converts the variable, circular image to a linear, planar image for display to the operator. The algorithm uses a geometric normalization to remove the variation of the conical mirror light intensity so that the true scintillator light intensity is displayed and readily evaluated by the analysis software routines.

While this invention has been illustrated and described in accordance with a preferred embodiment, it is recognized that variations and changes may be made therein without departing from the invention as set forth in the claims.

What is claimed is:

1. A scintillator camera system for determining uniformity of radiation emission from one or more radioactive sources comprising:
a cylindrical scintillator having a central hole for receiving one or more radioactive sources, the scintillator being adapted to permit light stimulated in the scintillator by the one or more radioactive sources in the central hole to exit out of the sides of the scintillator;
a conical reflector at least partially surrounding the cylindrical scintillator and arranged to reflect light that exits the sides of the scintillator and direct the light in a first direction;
a camera arranged to detect the light reflected from the conical reflector and produce image data corresponding to the detected light.

2 The system of claim 1, wherein the scintillator is a solid glass scintillator.

3. The system of claim 1, wherein the scintillator is an inorganic scintillator.

4. The system of claim 1, wherein the scintillator is a fiber optic scintillator having fibers directed in a radial direction of the scintillator.

5. The system of claim 1, wherein the scintillator has a polished perimeter.

6. The system of claim 1, wherein the scintillator includes a coating of phosphor on an outer side of tissue-equivalent plastic separators of various thicknesses surrounding the central hole and arranged in one of steps and a cone.

7. The system of claim 1, wherein the scintillator is a tissue-equivalent plastic with an outer cylindrical surface is coated with a phosphor.

8. The system of claim 1, wherein the scintillator includes a phosphor cylinder.

9. The system of claim 1, further comprising radiation shielding on the scintillator.

10. The system of claim 9, wherein the radiation shielding includes at least one of lead and tungsten alloy.

11. The system of claim 9, wherein the radiation shielding is plastic.

12. The system of claim 1, further comprising a computer for analyzing radiation emission patterns corresponding to the image data.

13. A cylindrical scintillator having a central hole for receiving one or more radioactive sources, the scintillator being adapted to permit light stimulated in the scintillator by the one or more radioactive sources in the central hole to exit out of the sides of the scintillator.

14. The scintillator of claim 13, wherein the scintillator is a solid glass scintillator.

15. The scintillator of claim 13, wherein the scintillator is an inorganic scintillator.

16. The scintillator of claim 13, wherein the scintillator is a fiber optic scintillator having fibers directed in a radial direction of the scintillator.

17. The scintillator of claim 13, wherein the scintillator has a polished perimeter.

18. The scintillator of claim 13, wherein the scintillator includes a coating of phosphor on an outer side of tissue-equivalent plastic separators of various thicknesses surrounding the central hole and arranged in one of steps and a cone.

19. The scintillator of claim 13, wherein the scintillator is a tissue-equivalent plastic with an outer cylindrical surface is coated with a phosphor.

20. The scintillator of claim 13, wherein the scintillator includes a phosphor cylinder.

21. The scintillator of claim 13, further comprising radiation shielding on the scintillator.

22. The scintillator of claim 21, wherein the radiation shielding is one of a leaded plastic or leaded glass and provides radiation shielding while permitting observation of the scintillator.

23. The scintillator of claim 21, wherein the radiation shielding is plastic.

24. A method for determining uniformity of radiation emission from one or more radioactive sources, comprising:
inserting a radioactive source in a central hole of a scintillator, the scintillator being adapted to permit light stimulated in the scintillator by the radioactive source in the central hole to exit out of the sides of the scintillator;
reflecting light that exits the sides of the scintillator with a reflector and directing the light in a first direction; and
after the light has been directed in the first direction, detecting the light with a camera.

25. The method of claim 24, wherein, prior to detecting the light with the camera, reflecting the light in a second direction with a second reflector.

26. The method of claim 24, further comprising analyzing, with a computer, radiation emission patterns corresponding to light detected with the camera.
